(19) United States
(12) Patent Application Publication
(10) Pub. No.: US 2010/0195162 A1
(43) Pub. Date: Aug. 5, 2010

(54) Color To Monochrome Conversion

(76) Inventor: Peter Majewicz, Boise, ID (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/366,420

(22) Filed: Feb. 5, 2009

(51) Int. Cl. H04N 1/40; G09G 5/02

(52) U.S. Cl. 358/3.23; 345/591

(57) ABSTRACT

A digital image processing method and system converts color images to monochrome images. Color image data is clustered. Centroids of clusters are mapped to monochrome values. The separation of the monochrome levels is adjusted, based on relative significance of corresponding clusters. Color pixels in the clusters are mapped to the adjusted monochrome levels, and the resulting monochrome pixels are rendered.

### DESCRIPTION OF THE RELATED ART

In digital imaging there is a general need for conversion of color images into monochrome images, for example for printing on a monochrome printer or displaying on a monochrome display. The most common monochrome image is a grayscale image. Typically, each pixel in a digital color image is encoded as three values. Each value may represent the intensity of a band of wavelengths of light, for example, red-green-blue (RGB), or yellow-magenta-cyan. As an alternative example, one value may represent luminance and the other two values may represent chrominance. For conversion to a monochrome image, if the color image values are luminance-chrominance, some devices simply use the luminance value, ignoring the chrominance values. If the color images are three colors, some devices simply use one of the three color values (for example, green) and print or display the intensity values of the single color. More commonly, the three color values are weighted and added to obtain one weighted-sum intensity value for each pixel.

Some colors that are distinct to the human visual system may have almost the same luminance value, or weighted intensity value, so that areas that are visually distinct in a color image cannot be distinguished in the converted monochrome image. This is of particular concern for computer generated images (for example, graphics, pie charts, maps, etc.) where colors are purposefully chosen for the ability of the human visual system to discriminate lines or areas, but a monochrome version of the image has lines or areas that are indistinguishable or undesirably similar.

Sometimes (for example, computer generated images having a small number of colors), distinction of areas in a converted monochrome image is more important than an accurate rendering of intensity. There are known methods to maximize differentiability. However, methods that maximize differentiability may not be suitable for color images of natural scenes, for example, from a digital camera. In addition, if a color print of a computer generated image is scanned (for example, in a digital copier), the scanning process may incorporate edge smoothing (which may produce a gradation of colors), and may add color noise, so that algorithms that maximize differentiability may produce monochrome images having undesirable artifacts or otherwise aesthetically unpleasing monochrome images.

There is an ongoing need for color to monochrome conversion that provides aesthetically pleasing monochrome images for a wide variety of color images.

### BRIEF DESCRIPTION OF THE DRAWINGS

FIG. 1 is a block diagram of an example system incorporating the example color to monochrome conversion methods.

FIG. 2 is a block diagram of another example system incorporating the example color to monochrome conversion methods.

FIG. 3 is a flow chart of an example method for color to monochrome conversion.

FIGS. 4A and 4B are two parts of an example flow chart depicting the example method of FIG. 3 with example additional optional steps.

### DETAILED DESCRIPTION

In the following discussion, two example systems are discussed in which the example methods might be implemented. Next, an example method is presented, which uses pixel clustering, and which uses cluster significance to provide improved contrast and distinctiveness. Then, examples of additional optional steps are presented. Next, additional detail is provided for example implementations of some of the steps. Finally, example equations and pseudo code are provided for some of the steps.

Color to monochrome conversion methods and systems are disclosed that adaptively convert color images to monochrome images. That is, for each color image to be converted, the color information in the image is used to determine the conversion values. The disclosed methods are particularly useful for improving distinctiveness and contrast in images that are noisy or complex, for example digital photographs or scanned images.

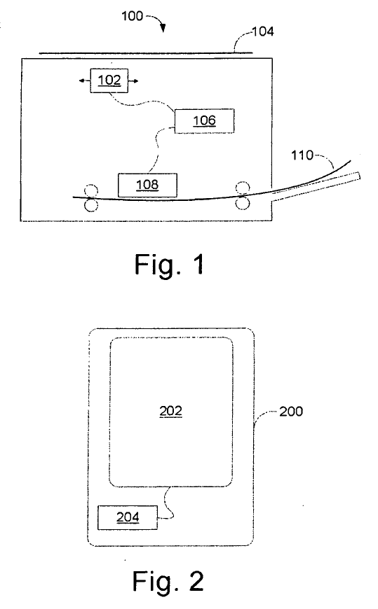

FIG. 1 illustrates an example system in which the invention may be especially useful. FIG. 1 illustrates a copier 100. A scanning head 102 is obtaining color image data from a document 104. A processor 106 converts the color image data to monochrome data, and sends the monochrome data to a print head 108, which in turn renders a monochrome image on a sheet of paper 110.

The example system depicted in FIG. 1 illustrates an integrated system. The invention is equally applicable in a system in which the image input device (for example, a camera or scanner), the image processing system, and the image rendering device (for example, printer or display) are all separate. Alternatively, the image input device and image processing system may be combined, separate from the image rendering device. Alternatively, the image processing device may be combined with the image rendering device, separate from the image input device.

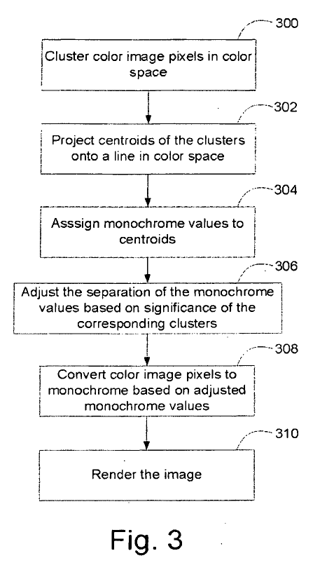

FIG. 2 illustrates another example system in which the invention may be especially useful. FIG. 2 illustrates a personal digital appliance 200 having a monochrome display 202 being controlled by a processor 204. Of particular interest are portable electronic reading devices (“electronic books”), used for storing and displaying electronic versions of books, magazines, newspapers, etc. The images being displayed may be electronically generated data (for example, computer graphics), or the data may come from scanned documents, or the data may come from digital cameras. Typically, for electronic reading devices, the displays are monochromatic to reduce cost and to reduce power. FIG. 2 depicts a display on the surface of the reader, but some proposed devices have flexible displays that roll out of the reader.

Image rendering devices, such as the printing head 108 in FIG. 1, or the display 202 in FIG. 2, may generate individual pixels of varying lightness (printer) or intensity (display). Alternatively, the devices may be binary, so that varying lightness or intensity is achieved by half-toning, dither patterns, error diffusion, or other methods such that binary rendering appears to have varying lightness or intensity to the human visual system. The methods discussed in the present application generate an image containing variable lightness or variable intensity monochrome data, and the details of how the rendering device implements a variable lightness or variable intensity monochrome image for the human visual system are not important to the present invention.

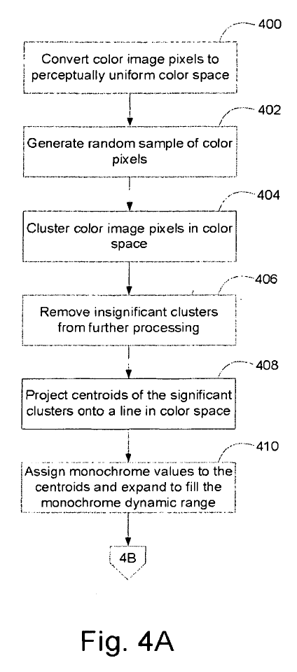

FIG. 3 illustrates an example method for color to monochrome conversion. First, at step 300, image pixels in a color space are partitioned into clusters. There are many ways to cluster pixels in image processing. The following is one example. A first pixel is retrieved and a first cluster is defined as having a centroid at the value of the first pixel. A second pixel is retrieved. If the second pixel is within a predefined radius of the first pixel, it is added to the first cluster, and the centroid is recalculated to be the centroid of the two pixels (average position in color space of the two pixels). If the second pixel is further away than the threshold distance, then a second cluster is defined. As more pixels are retrieved, they are added to existing clusters if they are close (within the predefined radius) to the centroid of an existing cluster (and the centroid is recomputed), or they define the beginning of a new cluster. As pixels are clustered, the centroids of the clusters move. After a predefined number of pixels are clustered, the centroid of each cluster is checked to see if it is within a predefined radius of the centroid of another cluster, and if so, the clusters are merged. The process is repeated with more pixels and more merging of clusters.

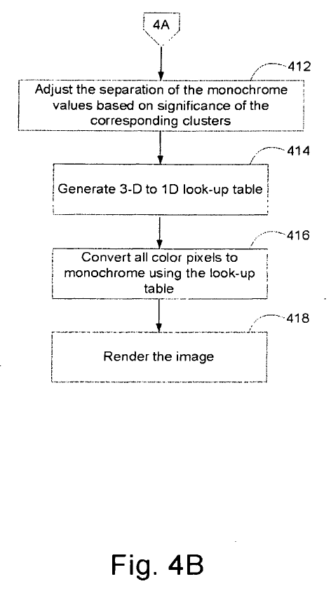

At step 302, the centroid (average value of all the pixels in the cluster) of each cluster is projected onto a line in the color space. An example method for generating a line in color space is provided in the discussion of FIG. 4A.

The projected centroids of some clusters may be relatively close together, which reduces contrast and distinctiveness. At step 304, monochrome values are assigned to the centroids, and at step 306, the separation of the monochrome values is adjusted to improve contrast and distinctiveness. Note that step 304 is not necessarily an explicit step, but rather is a conceptual step in conjunction with step 306. Step 306 could operate directly on projected centroids. However, it is computationally convenient to simply map distance along the line for each centroid to a single monochrome value, and then adjust the monochrome values. For example, assuming that each monochrome pixel value is eight bits, each projected centroid along the line in color space may be mapped to a value in the range of 0-255 in proportion to its distance along the line in color space. Note that the clusters are not being moved, but instead a monochrome value associated with each cluster is being adjusted. Providing more separation between the monochrome values improves contrast and distinctiveness, but moving one monochrome value may just cause crowding in the opposite direction. In addition, it is more important visually to have a greater separation for values associated with the most significant (highest number of pixels per unit volume in color space) clusters than for the least significant clusters.

The problem of adjusting separation of monochrome values is a global optimization problem, where the separation of all the monochrome values from their neighbors, along with making the separation of values associated with highly significant centroids more important than the separation for values associated with less significant centroids, which needs to minimize some global measurement. The following example process is called simulated annealing, inspired by annealing in metallurgy. Simulated annealing is an algorithm for locating an approximation to a global minimum of a given function (called a “heating” function) in a large search space. In each step, an existing solution is replaced by a random “nearby” solution, dependent on a global parameter (called “temperature”), which is gradually decreased. In this example application to color conversion, a heating function is defined, and an error function is defined. The temperature is a unit of intensity or lightness in the monochrome space, and the temperature is reduced at each iterative step. A fraction of the projected centroids have their position on the line changed randomly plus or minus the temperature, and the resulting heating function is computed for the fraction of the centroids. If the error function for the new values is less than the error function for the previous values, the new values are retained. The temperature is gradually decreased to zero, and the end result is a shifting of the projected centroids. Pseudo code for this example method is provided later in this document.

At step 308, each color pixel in each cluster is mapped to the shifted monochrome value corresponding to the cluster. At step 310, the image is rendered, for example, on a printer or display.

Adjusting the monochrome values, where the adjustment is a function of significance of the corresponding clusters, is an important step in improving contrast and distinctiveness in the monochrome image. There are many other optional process steps that may be performed to provide even more contrast and distinctiveness, to reduce the effects of noise and scanning artifacts, and to improve the computational efficiency. FIGS. 4A and 4B illustrate the basic method of FIG. 3 along with multiple additional optional example enhancements.

The human visual system is nonlinear, being more sensitive to some wavelengths of light than others, and nonlinear in the perception of intensity. If one takes samples pairs of colors having uniform Euclidian distances in RGB space, a human observer will perceive some pairs as more distinct than others. Color spaces have been developed in which uniform distances are perceived by an “average” human observer as having uniform color differences. One example is specified by the Commission Internationale d'Eclairage (CIE), and is called CIE 1976 (L*, a*, b*), also called CIELAB. CIELAB describes all the colors visible to the human eye and was created to serve as a device independent reference. IEC 61966-2-1:1999 provides standard equations for conversion of sRGB (standard red-green-blue) to CIELAB. At step 400 in FIG. 4A, if the color image is not already in a perceptually uniform color space, the pixels are preferably converted to a perceptually uniform color space before clusters are determined. Performing the operations described in this document in a perceptually uniform color space such as CIELAB facilitates converting colors that are distinctive to monochrome values that are distinctive.

Images may contain tens of millions of pixels. To decrease processing time, a random sample of the pixels from the original image may be used for the clustering and projection steps. At step 402, the image processing system generates a random sample of the original color image pixels.

At step 404, the color pixels are clustered in the color space. A complex image may generate so many clusters that it is not possible to provide visual distinctiveness in monochrome for each cluster. In addition, some clusters may contain primarily noise or scanning artifacts. At step 406, the significance (spatial pixel density) of each cluster is determined, and the insignificant clusters are removed from further processing. That is, if a cluster has a pixel density lower than a predetermined threshold, then the cluster is removed from further processing. Removing insignificant clusters improves contrast and distinctiveness for the remaining clusters.

At step 408, centroids of the significant clusters are projected onto a line in the color space. There are numerous algorithms for determining a line that reduces the probability that centroids from separate clusters might project to the same or nearly the same point on the line. Some of those algorithms are optimized for a specific class of images, such as photos of human faces, or computer generated graphics. The following example for determining a line is suitable for a large variety of image types. A line is generated through the mean of all the significant clusters, and through the centroid of the significant cluster having the greatest value of L* (in CIELAB space).

At step 410, the projected centroids are mapped to monochrome values, and the monochrome values are optionally expanded to fill the monochromic dynamic range. For example, assume that the monochrome pixel values are each eight bits, and that a value of zero is the lowest intensity or lowest lightness, and a value of 255 is the highest intensity or highest lightness. The darkest centroid is given a monochrome value of zero, and the lightest centroid on the color line is given a monochrome value of 255, and the rest of the mapped monochrome values are linearly scaled to the end points in proportion to distance along the line in color space.

At step 412 of FIG. 4B, the separation of the expanded monochrome values is adjusted, based on the significance of the corresponding clusters (for example, by using simulated annealing). Note that step 410 may be redundant in some cases since step 412 alone may sometimes result in monochrome values being shifted to the ends of the dynamic range.

For processing efficiency, a color look-up table may be computed based on the monochrome values resulting from step 412. At step 414, a 3-D to 1-D (for example, RGB to grayscale) look-up table is computed. The following is one example. In image processing, the example process is called distribution free classification, meaning that the method does not have any prior knowledge of the distribution of the pixels. A particular type of distribution free classification is called a decision tree classifier, which splits the 3-dimensional space into unique regions by a sequential method. Partitions (planes) are sequentially moved until each centroid is within a six sided box. A color pixel within a box maps to a monochrome value corresponding to the cluster centroid within the box. Note that as a result of removing some clusters from consideration in step 406, some regions of color space will not contain a cluster centroid, and color pixels falling in one those regions of color space will not be converted or rendered.

At step 416, all the pixels corresponding to significant clusters are converted to monochrome values using the look-up table. At step 418, the resulting monochrome image is rendered, for example, on a printer or on a display.

Identifying significant color clusters, and removing insignificant color clusters reduces the effects of noise and some scanning artifacts, and increases contrast and distinctiveness. Expanding monochrome values to the limits of the monochrome range improves dynamic range so that, for example for grayscale, the lightest areas map to pure white and darkest areas map to pure black. Finally, the adjusted separation step makes the more significant colors “standout” over less significant colors in the image, making large area fills more prominent and enhances the perceived contrast of the monochrome representation.

The following example pseudo-code generates a random set of pixels as in FIG. 4A, step 400. Let (R^{I}, G^{I}, B^{I}) be the sets of pixels of the 3 channels of the color image to be converted to monochrome. The code generates a small random sample set (R^{II}, G^{II}, B^{II}) of the all the pixels. Let (Rᵢ^{I}, Gᵢ^{I}, Bᵢ^{I}) denote the 3 channel values of the i^{th} pixel. Let m^{I} be the total number of pixels. Let rand be a function that generates a random number between 0 and 1 each time it is called. Let Q be the maximum signal level that the channels can encode. Let k₁ be the fraction of the total pixels to be sampled. m^{II} is the number of pixels in the set when the for loop completes. The suggested value of k₁ is 0.001 for a 300 DPI letter size image. This value will produce a random sample set of approximately 8,415 pixels for the letter size image. For repeatable color-to-grayscale conversion, the same random number generator seed value should be used each time. The following pseudo-code generates the set:

```
J = 0
for i = 0 to m^{I} − 1
  {
        if rand < k₁ then
        {
        Rⱼ^{II} = Rᵢ^{I}
    Gⱼ^{II} = Gᵢ^{I}
    Bⱼ^{II} = Bᵢ^{I}
        j = j + 1
        }
    }
m^{II} = j
```

The following example pseudo-code performs cluster analysis, as in FIG. 3, step 300, and FIG. 4A, step 404. The minimum cluster separation can be specified so that the 3D space can be finely or coarsely quantized. Let k₂ be the radius of the clusters to be identified. The suggested value of k₂ is 5. Let k₃ be the fractional number of total pixels to be searched between merging operations. The suggested value of k₃ is 0.10. This value will cause 10 merging operations to occur during the course of the clustering. Let de94(Lₓ, aₓ, bₓ, L_{y}, a_{y}, b_{y}) be a function that calculates the color difference between 2 points (Lₓ, aₓ, bₓ) and (L_{y}, a_{y}, b_{y}). Denote the j^{th} cluster centroid as (Lⱼ^{III}, aⱼ^{III}, bⱼ^{III}), and the number of pixels in that cluster as numpixⱼ^{III}. There will be m^{III} total clusters when the clustering completes.

```
L₀^{III} = L₀^{II} , a₀^{III} = a₀^{II} , b₀^{III} = b₀^{II} , numpix₀^{III} = 1, m^{III} = 1, the 1^{st} pixel is
the 1^{st} cluster
r = 1, s = 0
for i = 1 to m^{II} − 1, loop through all pixels in the sample set
    {
        NewClusterFlag = true
        for j = 0 to m^{III} − 1, loop through all previously
discovered clusters
            {
      Δ = de94(Lⱼ^{III}, aⱼ^{III}, bⱼ^{III}, Lᵢ^{II}, aᵢ^{II}, bᵢ^{II}), distance between cluster
      and pixel
      if Δ < k₂ then, the pixel is inside a previously discovered
      cluster so re-center the cluster centroid by averaging in the
      position of the new pixel
      {
            NewClusterFlag = false
            numpixⱼ^{III} = numpixⱼ^{III} + 1
            Lⱼ^{III} = (Lⱼ^{III}(numpixⱼ^{III} − 1) + Lᵢ^{II})/numpixⱼ^{III}
            aⱼ^{III} = (aⱼ^{III}(numpixⱼ^{III} − 1) + aᵢ^{II})/numpixⱼ^{III}
            bⱼ^{III} = (bⱼ^{III}(numpixⱼ^{III} − 1) + bᵢ^{II})/numpixⱼ^{III}
            Jump exit out of the for j loop
                } end if
            } end for j loop
    if NewClusterFlag then, have found a new cluster so add it to the
    list
    {
      Lⱼ₊₁^{III} = Lᵢ^{II}
      aⱼ₊₁^{III} = aᵢ^{II}
      bⱼ₊₁^{III} = bᵢ^{II}
      numpixⱼ₊₁^{III} = 1
    }
    if r ≡ └ k₃m^{II} ┘ then merge near clusters
    {
        MergeFlag = false, ContinueFlag = true, r = 0, t = 1
        while ContinueFlag
                {
        q = t + 1
            if q < m^{III} then { ContinueFlag2 = true } else {
ContinueFlag2 = false }
            while ContinueFlag2
                    {
        Δ = de94(Lₜ^{III}, aₜ^{III}, bₜ^{III}, L_{q}^{III}, a_{q}^{III}, b_{q}^{III}),
                        if Δ < k₂ then, merge the clusters
into a single new centroid
        {
                        n = numpixₜ^{III} + numpix_{q}^{III}
    Lₜ^{III} = (numpixₜ^{III}Lₜ^{III} + numpix_{q}^{III}L_{q}^{III})/n
    aₜ^{III} = (numpixₜ^{III}aₜ^{III} + numpix_{q}^{III}a_{q}^{III})/n
    bₜ^{III} = (numpixₜ^{III}bₜ^{III} + numpix_{q}^{III}b_{q}^{III})/n
                        numpixₜ^{III} = n
                        delete (L_{q}^{III}, a_{q}^{III}, b_{q}^{III}) from the set
of clusters
                        m^{III} = m^{III} − 1
        MergedFlage = true
                            }
        else
          {
          q = q + 1
          }
            if q > m^{III} then { ContinueFlag2 = false }
        } end while ContinueFlag2
        t = t + 1
        if t > m^{III} and MergedFlag then { t = 1, MergedFlag =
      false }
                        if t > m^{III} and ~MergedFlag
then { ContinueFlag = false }
                    } end while ContinueFlag
                } end merge near clusters
        r = r + 1
    } end for i loop
```

The following example pseudo-code removes insignificant clusters, as in FIG. 4A, step 406. The density of each cluster is compared against a threshold k₄. If the density is below the threshold, then the cluster is considered insignificant and removed from further consideration. The suggested value for k₄ is 0.001. This step reduces the m^{III} clusters generated in step 404 to m^{IV} clusters and generates new sets (L^{IV}, a^{IV}, b^{IV}).

```
j = 0
for i = 0 to m^{III} − 1, loop through all clusters
    {
        If numpixᵢ^{III} ≧ └ k₄m^{III} ┘ then, add the cluster to the new
set
        {
            (Lⱼ^{IV}, aⱼ^{IV}, bⱼ^{IV}) = (Lᵢ^{III}, aᵢ^{III}, bᵢ^{III})
            Numpixⱼ^{IV} = numpixᵢ^{III}
            j = j + 1
        }
    }
m^{IV} = j
```

The following example pseudo-code generates a line passing through the centroid with the greatest L* and through the mean of all the clusters. Let

u=arg maxⱼ(Lⱼ^{IV})

be the index of the cluster with greatest L*, and let

(L^{offset}, a^{offset}, b^{offset})=(Lᵤ^{IV}, aᵤ^{IV}, bᵤ^{IV})

be the corresponding cluster.
Denote (L^{mean}, a^{mean}, b^{mean}) as the mean of all the clusters. The unit vector that points in the direction of the best fit line is

$${L}^{direction} = \frac{{L}^{offset} - {L}^{mean}}{{[ \begin{matrix}{( {L}^{offset} - {L}^{mean} )}^{2} + {( {a}^{offset} - {a}^{mean} )}^{2} + \\ {( {b}^{offset} - {b}^{mean} )}^{2}\end{matrix} ]}^{1 / 2}}$$

$${a}^{direction} = \frac{{a}^{offset} - {a}^{mean}}{{[ \begin{matrix}{( {L}^{offset} - {L}^{mean} )}^{2} + {( {a}^{offset} - {a}^{mean} )}^{2} + \\ {( {b}^{offset} - {b}^{mean} )}^{2}\end{matrix} ]}^{1 / 2}}$$

$${b}^{direction} = \frac{{b}^{offset} - {b}^{mean}}{{[ \begin{matrix}{( {L}^{offset} - {L}^{mean} )}^{2} + {( {a}^{offset} - {a}^{mean} )}^{2} + \\ {( {b}^{offset} - {b}^{mean} )}^{2}\end{matrix} ]}^{1 / 2}}$$

The best fit line in parametric form is then

L^{fit}(t)=L^{offset}+L^{direction}t

a^{fit}(t)=a^{offset}+a^{direction}t

b^{fit}(t)=b^{offset}+b^{direction}t

where t ε real_numbers.

The following example pseudo-code projects the cluster centroids onto the line in color space, as in FIG. 3, step 302, and FIG. 4A, step 408. The i^{th} inner product projection is

Ωᵢ^{I}=<(Lᵢ^{IV}, aᵢ^{IV}, bᵢ^{IV})−(L^{offset}, a^{offset}, b^{offset}), (L^{direction}, a^{direction}, b^{direction})>

The following example equation expands the monochrome values to fill the dynamic range of the monochrome representation. The monochrome values of the mappings are sorted from least to greatest with the sorting stored in indexing look-up-table LUT^{I}( ) and then assigned a new value by the following equation:

$${Ω}_{i}^{II} = \frac{( Q - 1 )}{{m}^{IV}} {LUT}^{I} ( i )$$

The following example pseudo-code further adjusts the monochrome mappings, as in FIG. 3, step 306, and FIG. 4B, step 412, using simulated annealing (SA). This step moves the monochrome values associated with clusters having a high density away from the monochrome values of neighbors associated with clusters having a low density. The movement makes more significant colors “standout” over less significant colors in the image. That is, it makes large area fills more prominent and enhances the perceived contrast of the grayscale representation.

SA requires an error metric for to the set to be adjusted and a heating function that slightly changes the set. The example error metric is a function of the spacing between the monochrome values and the cluster densities. It is:

$$err ( Ω ) = \sqrt{{\sum }_{j = 0}^{{m}^{IV} - 2} {( \frac{{numpix}_{i}^{IV}}{{Ω}_{i + 1} - {Ω}_{i} + 1} )}^{2}}$$

The heating function Ωout=heat(h,Ωin) picks a fraction h of the clusters at random and changes their monochrome value by ±1 at random. Pseudo-code for the heating function follows:

```
for i = 0 to m^{IV} − 1 { Ωoutᵢ = Ωinᵢ }
for i = 0 to └ m^{IV}h ┘
    {
    j = └ rand*m ┘
    if rand > 0.5 then { Ωoutⱼ = Ωinⱼ + 1 } else { Ωoutⱼ = Ωinⱼ − 1 }
    }
```

Now, the SA steps the heat from 1 down to 0 in an asymptotic 4^{th} power curve to generate the adjusted monochrome mapping Ω^{III}. Pseudo-code for the SA follows:

Ω^{III} = Ω^{II}
for j = 1000 to 1 by −1 steps

{

$h = {( \frac{j}{1000} )}^{4}$
Ω = heat(Ω^{III}, h)
If err(Ω) < err(Ω^{III}) then {Ω^{III} = Ω}

}

What is claimed is:

1. A method for converting a color image to a monochrome image, comprising:
identifying, by a processor, clusters of pixels in the color image that are close together in a color space;
projecting, by the processor, centroids of the clusters onto a line in the color space;
assigning, by the processor, monochrome values to the centroids;
adjusting, by the processor, the separation of the monochrome values based on significance of the corresponding clusters;
converting, by the processor, the pixels in the color image to monochrome pixel values based on the adjusted monochrome values; and
rendering the monochrome pixel values onto an imaging device.

2. The method of claim 1, further comprising, before the step of identifying, converting, by the processor, pixels in the color image to a perceptually uniform color space.

3. The method of claim 1, further comprising, before the step of identifying, generating, by the processor, a random sample of pixels in the color image.

4. The method of claim 1, the step of identifying further comprising, merging clusters that are relatively close together in the color space.

5. The method of claim 1, further comprising, after the step of identifying:
selecting, by the processor, as significant clusters, those clusters having a spatial density of pixels greater than a predetermined threshold; and
removing, by the processor, the remaining clusters from consideration.

6. The method of claim 1, the step of projecting further comprising:
fitting, by the processor, a line in the color space that passes through the centroid of the cluster having the greatest luminance, and passes through the mean of the centroids of all the clusters being processed; and
projecting, by the processor, centroids of the clusters being processed onto the line in the color space.

7. The method of claim 1, further comprising, after the step of assigning:
expanding, by the processor, the monochrome values to fill the monochromatic dynamic range.

8. The method of claim 1, the step of adjusting further comprising using simulated annealing to determine the separation.

9. The method of claim 1, the step of converting further comprising using decision tree classification to define regions in color space that include the centroids.

10. The method of claim 1, the step of rendering further comprising:
generating, by the processor, a look-up table, for mapping color space values to the adjusted monochrome values; and
using, by the processor, the look-up table to convert each color image pixel to a monochrome value.

11. A system, comprising:
a processor;
an image rendering device;
wherein the processor reads color pixel data and clusters the color pixel data in a color space;
wherein the processor projects centroids of the clusters onto a line in the color space;
wherein the processor assigns monochrome values to the centroids based on positions on the line in color space;
wherein the processor adjusts the separation of the monochrome values based on the spatial pixel density of the clusters corresponding to the monochrome values; and
wherein the processor maps color pixel data to a corresponding monochrome value and sends the monochrome value to the image rendering device which in turn renders the monochrome value.

12. The system of claim 11, wherein the image rendering device is a printer.

13. The system of claim 11, wherein the image rendering device is a display.

14. The system of claim 11, wherein the system is a copier.

15. The system of claim 11, wherein the system is a personal digital appliance.

16. A system, comprising:
means for clustering color pixels within a color space;
means for projecting centroids of clusters onto a line in the color space;
means for mapping the projected positions of the centroids on the line to monochrome values;
means for shifting the monochrome values based on significance of corresponding clusters;
means for mapping color pixels in the clusters to monochrome pixel values equal to the corresponding shifted monochrome values; and
means for rendering the monochrome pixel values.

17. The system of claim 16, wherein the image rendering device is a printer.

18. The system of claim 16, wherein the image rendering device is a display.

19. The system of claim 16, wherein the system is a copier.

20. The system of claim 16, wherein the system is a personal digital appliance.
